(19) United States
(12) Patent Application Publication
(10) Pub. No.: US 2015/0220720 A1
(43) Pub. Date: Aug. 6, 2015

(54) ELECTRONIC DEVICE AND METHOD FOR CONTROLLING ACCESS TO GIVEN AREA THEREOF

(71) Applicant: Samsung Electronics Co., Ltd., Suwon-si (KR)

(72) Inventors: Youngkeun CHOI, Suwon-si (KR); Myungsu KANG, Seoul (KR); Keumju JANG, Seoul (KR); Sunmin HWANG, Hwaseong-si (KR); Hyungsuk HWANG, Hwaseong-si (KR)

(21) Appl. No.: 14/602,666

(22) Filed: Jan. 22, 2015

(30) Foreign Application Priority Data
Feb. 3, 2014 (KR) 10-2014-0011909

(51) Int. Cl. G06F 21/34; G06F 21/62

(52) U.S. Cl. CPC G06F 21/34; G06F 21/6218

(57) ABSTRACT

A method for operating an electronic device is provided. The method includes determining validity of a first key, generating, when the first key is valid, a second key, and granting access to a designated area of the electronic device by use of the second key. Other various embodiments are possible on the basis of the above method.

### CROSS-REFERENCE TO RELATED APPLICATION(S)

This application claims the benefit under 35 U.S.C. §119(a) of a Korean patent application filed on Feb. 3, 2014 in the Korean Intellectual Property Office and assigned Serial number 10-2014-0011909, the entire disclosure of which is hereby incorporated by reference.

### TECHNICAL FIELD

The present disclosure relates to an electronic device and a method for controlling access to a given area in the electronic device.

### BACKGROUND

An electronic device equipped with a storage unit, a processor, and an operating system (OS), such as a smartphone and/or tablet computer, may execute a variety of applications. In particular, such a portable electronic device may be used to perform online business transactions and financial transactions.

Security is a common issue in performing security critical functions, such as online business transactions and financial transactions. For security reasons, for example, a normal area and a secure area may be configured in an electronic device. The OS of the electronic device may regulate transfer of data between the different areas. For example, the OS may block unauthenticated access to the secure area from the normal area and allow authenticated access to the secure area. When multiple OSs are installed in the electronic device, the OSs may manage these areas individually. Such a device operation may raise a level of security in the secure area.

In general, accounts and passwords may be applied to authentication for access. Security cards, certificates, Internet Personal Identification Numbers (I-PIN), and one-time passwords (OTPs) may be used for authentication in addition to accounts and passwords.

The above information is presented as background information only to assist with an understanding of the present disclosure. No determination has been made, and no assertion is made, as to whether any of the above might be applicable as prior art with regard to the present disclosure.

### SUMMARY

Authentication schemes may have the following problems or shortcomings.

For schemes using accounts and passwords, accounts and passwords are exposed to a risk of hacking and/or loss. Actual security problems arise occasionally at portal and/or online service sites, which may provoke a stream of complaints from user groups.

For schemes using accounts, passwords, and security cards, a level of exposure to a security risk may be low unless a security card is lost or stolen. However, users performing many online business and/or financial transactions may have to carry their security cards, which are exposed to the risk of loss.

Schemes using certificates attempt to raise the level of security by means of digital authentication keys. However, certificates may have expiration dates. Also, users have to carry digital authentication keys, which are exposed to the risk of loss, and issuance of a digital authentication key may incur an expense.

Schemes using Internet Personal Identification Numbers (I-PINs) attempt to overcome shortcomings of certificates such as inconvenience due to possession and a risk of loss by authenticating identities through a server using encrypted passwords. Many institutions employ I-PINs for identity authentication because of ease of issuance. However, I-PINs are not used widely in online financial and commercial transactions owing to, for example, insecure identity authentication at the time of issuance.

Schemes based on One-Time Passwords (OTPs) are widely used as media of security class 1 in various fields, such as financing, portal services and online gaming. There are various versions such as mobile-OTP and ubiquitous OTP according to implementations. As the name suggests, an OTP is generated and used for one instance. OTP schemes may be time-synchronized and/or time/event-synchronized. In a time-synchronized scheme, the same OTP may be used unlimitedly for login for the valid period. In a time/event-synchronized scheme, the same OTP may be used for multiple occurrences of the same event for the valid period. All authentication techniques including OTP-based schemes may be vulnerable to hacking through phishing. In particular, entering information on the web may increase a risk of hacking.

Aspects of the present disclosure are to address at least the above-mentioned problems and/or disadvantages and to provide at least the advantages described below. Accordingly, an aspect of the present disclosure is to provide a method for protecting a designated area by controlling access to the designated area and an electronic device implementing the method.

In accordance with an aspect of the present disclosure, a method for operating an electronic device is provided. The method includes determining validity of a first key, generating, when the first key is valid, a second key, and granting access to a designated area of the electronic device by use of the second key.

In accordance with another aspect of the present disclosure, an electronic device is provided. The electronic device includes a communication unit configured to communicate with an external device, a memory unit including a normal area and a designated area, a control unit configured to control the communication unit and to access the memory unit, and an authentication unit configured to perform a process of determining validity of a first key, the first key being at least one of received through the communication unit and stored in the memory unit, to generate a second key when the first key is valid, and to permit the control unit to access the designated area by use of the second key.

In a feature of the present disclosure, the method and electronic device can provide a high level of security and convenience of usage by receiving a security key issued by a server and granting access to a designated area, e.g. a secure area, on the basis of the security key.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 illustrates a hardware configuration of an electronic device according to an embodiment of the present disclosure;

FIG. 3 illustrates a software configuration of an electronic device according to an embodiment of the present disclosure;

FIG. 4 is a block diagram of an electronic device according to an embodiment of the present disclosure;

FIG. 5 is a block diagram of an electronic device according to an embodiment of the present disclosure;

FIG. 6 is a flowchart of a user authentication procedure performed by an authentication server according to an embodiment of the present disclosure;

FIG. 7 is a flowchart of a method for controlling access to a secure area of an electronic device according to an embodiment of the present disclosure;

FIG. 8 is a flowchart of a method for controlling access to a secure area of an electronic device according to an embodiment of the present disclosure;

FIG. 9 is a flowchart of a method for controlling access to a secure area of an electronic device according to an embodiment of the present disclosure;

FIG. 10 is a flowchart of a method for controlling access to a secure area of an electronic device according to an embodiment of the present disclosure;

FIG. 11 is a flowchart of a method for controlling access to a secure area of an electronic device according to an embodiment of the present disclosure;

FIG. 12 is a flowchart of a method for controlling access to a secure area of an electronic device according to an embodiment of the present disclosure;

FIG. 13 is a flowchart of a method for controlling access to a secure area of an electronic device according to an embodiment of the present disclosure; and

FIG. 14 is a flowchart of a method for controlling access to a secure area of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the present disclosure, the electronic device may be a device capable of communication. For example, the electronic device may be a smartphone, a tablet computer, a mobile phone, a video phone, an e-book reader, a desktop computer, a laptop computer, a netbook computer, a personal digital assistant (PDA), a portable multimedia player (PMP), a motion picture experts group (MPEG) audio-layer 3 (MP3) player, a mobile medical instrument, an electronic bracelet, an electronic necklace, an electronic appcessory, a camera, a wearable device, an electronic clock, a wrist watch, a home appliance, e.g., a refrigerator, an air conditioner, an oven, a microwave oven, a washing machine, and an air cleaner, an intelligent robot, a television (TV), a digital video disc (DVD), an audio system, a medical instrument, e.g., a magnetic resonance angiography (MRA) scanner, a magnetic resonance imaging (MRI) scanner, computed tomography (CT) scanner, a tomograph, and an ultrasonic diagnostic equipment, a navigation aid, a global positioning system (GPS) receiver, an event data recorder (EDR), a flight data recorder (FDR), a set-top box, a streaming box, e.g., Samsung HomeSync, Apple TV, and Google TV, an electronic dictionary, a car infotainment device, a marine electronic device, e.g., a marine navigation system and a gyrocompass, avionics instrument, a security equipment, an electronic clothing, an electronic key, a camcorder, a game console, a head-mounted display, a flat panel display device, an electronic frame, an electronic album, part of a furniture or building supporting communication, an electronic board, an electronic signature receiver, or a projector, or a combination thereof. It should be understood by those skilled in the art that the electronic device according to the present disclosure is not limited thereto.

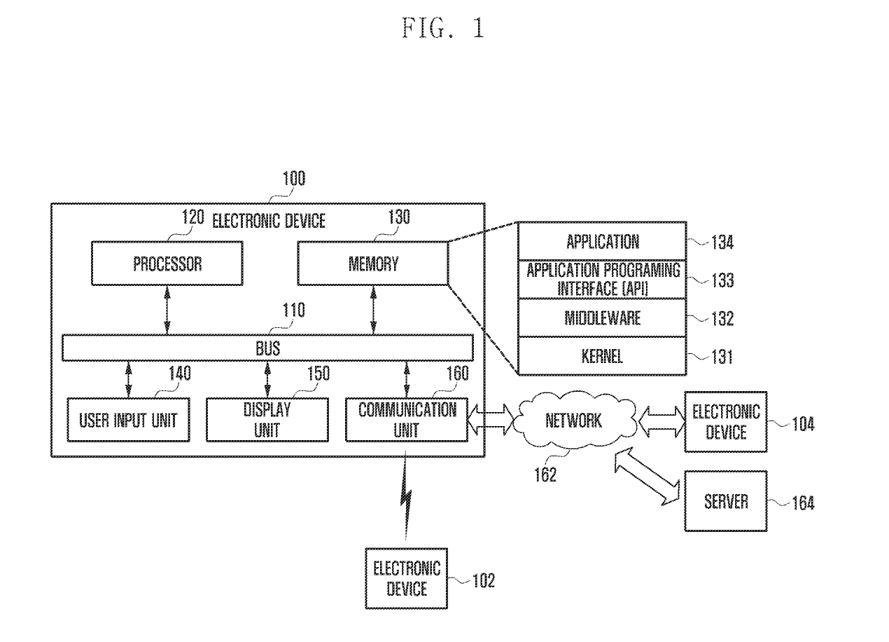

FIG. 1 is a block diagram of an electronic device according to an embodiment of the present disclosure.

Referring to FIG. 1, an electronic device 100 may include a bus 110, a processor unit 120, a memory unit 130, a user input unit 140, a display unit 150, and a communication unit 160.

The bus 110 may be a circuit interconnecting the above components for intercommunication therebetween, e.g. for exchange of control messages.

The processor unit 120 may receive instructions from other components, e.g. the memory unit 130, the user input unit 140, the display unit 150, and the communication unit 160, through the bus 110, decode the instructions, and perform operations and/or data processing according to the decoded instructions.

The memory unit 130 may store instructions and data received from and/or generated by the processor unit 120 and/or other components, e.g. the user input unit 140, the display unit 150, and the communication unit 160. The memory unit 130 may contain programming modules, such as a kernel 131, a middleware 132, an application programming interface (API) 133, and an application 134. Each programming module may be composed of software, firmware, hardware, or any combination thereof.

The kernel 131 may control and/or manage system resources, e.g. the bus 110, the processor unit 120, the memory unit 130, used to execute procedures and/or functions implemented by other programming modules, e.g. the middleware 132, the API 133, and the application 134. The kernel 131 may provide an interface that enables the middleware 132, the API 133, and the application 134 to access and/or control individual components of the electronic device 100.

The middleware 132 relays data between the API 133 and/or the application 134 and the kernel 131 for communication. As part of handling processing requests from the applications 134, the middleware 132 may load balance system resources of the electronic device 100, e.g. the bus 110, the processor unit 120, and the memory unit 130, by, for example, assigning priorities to the applications 134 making processing requests.

The API 133 provides interfaces and/or functions that may be invoked by the applications 134 to use services provided by the middleware 132 and/or the kernel 131. Here, the services may be related to management and/or control of files, windows, images, characters and the like.

The user input unit 140 may receive commands and/or data from the user and forward the same to the processor unit 120 and/or the memory unit 130 through the bus 110. The display unit 150 may display pictures, images and/or data to the user.

The communication unit 160 may connect the electronic device 100 to an external electronic device 102 for communication. The communication unit 160 may connect the electronic device 100 to a server 164. The communication unit 160 may connect the electronic device 100 to an external electronic device 104 via a network 162. The communication unit 110 may support communication through local area communication, e.g. Wi-Fi, Bluetooth, and/or Near Field Communication (NFC), or through the network 162, e.g. Internet, a local area network, a wide area network, a telecommunication network, a cellular network, a satellite network, and/or a Plain Old Telephone Service (POTS) network. The electronic devices 102 and 104 may be devices of the same type as the electronic device 100 or a device of a different type from the electronic device 100.

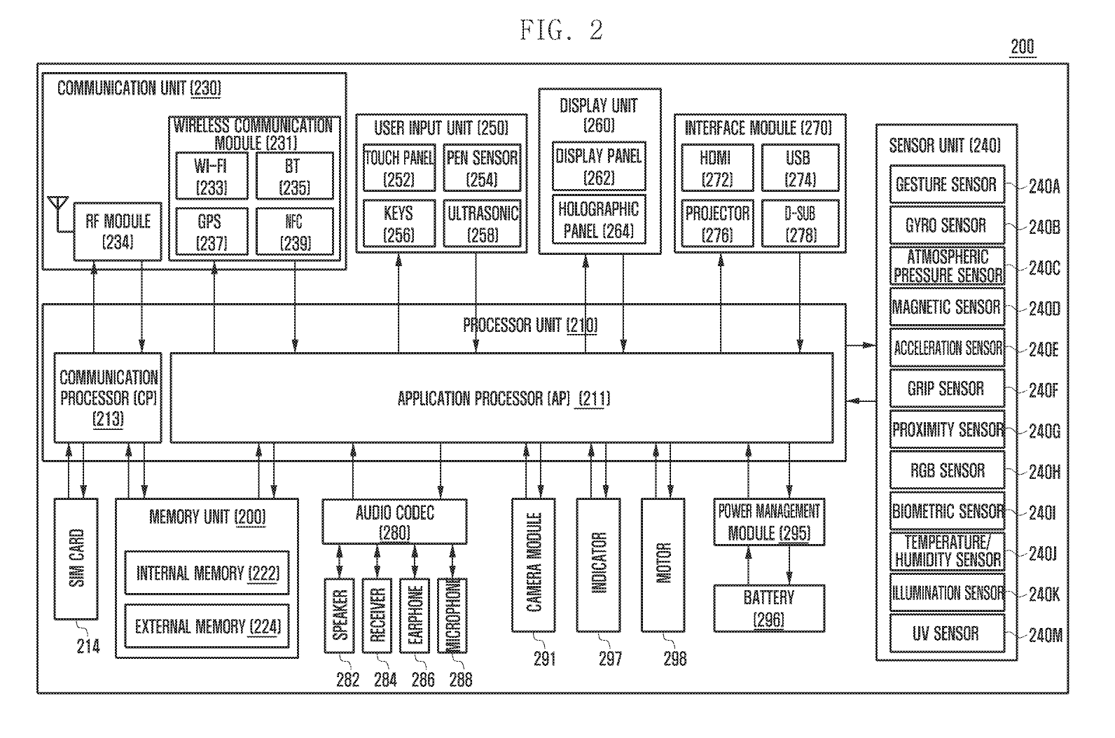

FIG. 2 illustrates a hardware configuration of an electronic device according to an embodiment of the present disclosure.

Referring to FIG. 2, a hardware 200 of an electronic device, such as the electronic device 100, may include a processor unit 210 including one or more processors, a Subscriber Identification Module (SIM) card 214, a memory unit 220, a communication unit 230, a sensor unit 240, a user input unit 250, a display unit 260, an interface module 270, an audio codec 280, a camera module 291, a power management module 295, a battery 296, an indicator 297, and a motor 298.

The processor unit 210 may include at least one application processor (AP) 211 and at least one communication processor (CP) 213. The processor unit 210 may correspond to the processor unit 120 shown in FIG. 1. The AP 211 and the CP 213 may be formed as a single integrated circuit (IC) package or may be formed as separate integrated circuit packages.

The AP 211 may execute the operating system or the application programs to control hardware and software components, process various data including multimedia, and perform various operations. The AP 211 may be implemented as a system on chip (SoC). According to an embodiment of the present disclosure, the processor unit 210 may further include a graphics processing unit (GPU) (not shown).

The CP 213 may perform data link management and protocol conversion for communication between the electronic device 100 and external electronic devices through networks. The CP 213 may be implemented in, for example, a SoC. The CP 213 may perform a part of multimedia control. For example, the CP 213 may perform device identification and authentication in a communication network using a subscriber identity module such as the SIM card 214. The CP 213 may provide the user with services related to voice calls, video calls, text messages and/or packet data.

The CP 213 may control data transmission and reception of the communication unit 230. Although the CP 213, the power management module 295, the memory unit 220, and the AP 211 are depicted as separate entities in FIG. 2, the present disclosure is not limited thereto, and the AP 211 may be configured to include one or more of these components, e.g. the CP 213.

The AP 211 and/or the CP 213 may load instructions and/or data received from a nonvolatile memory and/or another component in a volatile memory for execution. The AP 211 and/or CP 213 may store data received from and/or created by another component in the nonvolatile memory.

The SIM card 214 is a card for subscriber identification, and may be inserted in a slot formed at a portion of the electronic device. The SIM card 214 may contain unique identification information, such as an integrated circuit card identifier (ICCID) and/or subscriber information, such as an international mobile subscriber identity (IMSI).

The memory unit 220 may include an internal memory 222 and an external memory 224. The memory unit 220 may correspond to the memory unit 130 shown in FIG. 1. The internal memory 222 may include at least one of a volatile memory, e.g. a random access memory (RAM), a dynamic RAM (DRAM), a static RAM (SRAM), a synchronous DRAM (SDRAM)) and a nonvolatile memory, e.g. a programmable read only memory (PROM), a one time programmable ROM (OTPROM), an erasable programmable ROM (EPROM), and electrically erasable and programmable ROM (EEPROM), a mask ROM, a flash ROM, a NAND flash memory, and a NOR flash memory. The internal memory 222 may be in the form of a Solid State Drive (SSD). The external memory 224 may include a flash drive, such as, a compact flash (CF) drive, a secure digital (SD) drive, a Micro-SD drive, a Mini-SD drive, an extreme digital (xD) drive, and/or a Memory Stick.

The communication unit 230 may include a wireless communication module 231 and a radio frequency (RF) module 234. The communication unit 230 may correspond to the communication unit 160 shown in FIG. 1. The wireless communication module 231 may include a Wi-Fi module 233, a Bluetooth (BT) module 235, a global positioning system (GPS) module 237, and an NFC module 239. The wireless communication module 231 may use radio frequency waves to provide wireless communication. The wireless communication module 231 may further include a network interface, such as a Local Area Network (LAN) card and/or a modem for connecting to a network, such as the Internet, a LAN, a wide area network (WAN), a telecommunication network, a cellular network, a satellite network, and/or a POTS network.

The RF module 234 may use RF signals for data transmission and reception and/or call processing. The RF module 234 may include a transceiver, a power amplifier, a frequency filter, and a low noise amplifier (not shown). The RF module 234 may further include a component, such as a conductor and/or a wire to send and receive electromagnetic waves in free space.

The sensor unit 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a red, green, blue (RGB) sensor 240H, a biometric sensor 240I, a temperature/humidity sensor 240J, an illumination sensor 240K, and an ultraviolet (UV) sensor 240M. The sensor unit 240 may measure physical quantities and/or sense the operating status of the electronic device 100 and convert the measured and/or sensed information into an electrical signal. The sensor unit 240 may include an E-nose sensor, electromyography (EMG) sensor, an electrocardiogram (ECG) sensor, and a fingerprint sensor (not shown) in addition to or in place of the above sensors. The sensor unit 240 may further include a control circuit to control one or more of the above sensors.

The user input unit 250 may include a touch panel 252, a pen sensor 254, keys 256, and an ultrasonic input part 258. The user input unit 250 may correspond to the user input unit 140 shown in FIG. 1. The touch panel 252 may be a capacitive, resistive, infrared and/or ultrasonic touch panel capable of detecting user input. The touch panel 252 may include a controller (not shown). A capacitive touch panel may sense both a direct touch and an indirect touch. Here, a direct touch may indicate direct contact between a conductive object, e.g. a finger and/or a stylus pen, and the touchscreen. An indirect touch may indicate placement of a conductive object enclosed with a nonconductive object, e.g. a gloved finger, proximately to the touchscreen and/or contact between a nonconductive object, e.g. a glove on a finger, and the touchscreen. An indirect touch may also indicate contact between a finger and a nonconductive object, e.g. a protective cover, contacting with the touchscreen. An indirect touch may also indicate an event caused by a finger hovering on the touchscreen without direct contact. The touch panel 252 may include a tactile layer to provide a sense of touch to the user. The touch panel 252 may be disposed on the screen, i.e. the touchscreen, of the display unit 260. Specifically, the touch panel 252 may be of an add-on type, i.e., placed on the display unit 260, or of an on-cell or in-cell type, i.e., inserted into the display unit 260.

The pen sensor 254 may be a digital element that is configured to operate in a manner identical and/or similar to sensing user touch input and/or to operate using a separate recognition sheet. The keys 256 may include keypad and/or touch keys. The ultrasonic input part 258 may use a microphone 288 to detect a signal generated by a pen generating an ultrasonic signal, and may operate wirelessly. According to an embodiment, the hardware 200 may receive a user input from an external device, e.g. a network device, a computer, and/or the server 164, connected through the communication unit 230.

The display unit 260 may include a display panel 262 and a holographic panel 264. The display unit 260 may correspond to the display unit 150 shown in FIG. 1. The display panel 262 may be realized using liquid-crystal display (LCD) devices and/or active-matrix organic light-emitting diodes (AMOLED). The display panel 262 may be configured to be flexible, transparent and/or wearable. The display panel 262 may be combined with the touch panel 252 to form a single entity. The holographic panel 264 may use light interference to display a three-dimensional image in the air. The display unit 260 may include a control circuit to control the display panel 262 or the holographic panel 264.

The interface module 270 may include a high-definition multimedia interface (HDMI) 272, a universal serial bus (USB) interface 274, a projector interface 276, and a D-subminiature (D-sub) interface 278. The interface module 270 may include a SD/multi-media card (MMC) interface (not shown), and an infrared data association (IrDA) interface (not shown) in addition to or in place of the above interfaces.

The audio codec 280 may convert sound waves into electrical signals and vice versa. The audio codec 280 may transform sound data input from and/or output to, for example, a speaker 282, a receiver 284, an earphone 286 and the microphone 288.

The camera module 291 may capture still images and/or moving images. The camera module 291 may include at least one image sensor, such as a front lens and/or rear lens, an image signal processor (ISP), and a light-emitting diode (LED) flash (not shown).

The power management module 295 may manage power of the hardware 200. The power management module 295 may include a power management IC (PMIC), a charger IC, and a battery fuel gauge (not shown).

The PMIC may be embedded in an IC and/or SoC semiconductor. Wired charging and/or wireless charging may be utilized. The charger IC may charge a battery while protecting from overvoltage and/or overcurrent from a charger. The charger IC may be driven using wired and/or wireless charging technology. Magnetic resonance, magnetic induction and/or electromagnetic waves may be used for wireless charging. When wireless charging is used, ancillary circuits for charging, such as a coil loop, a resonator and/or a rectifier, may be added.

The battery fuel gauge may measure the remaining power, voltage during charging, current and/or temperature of the battery 296. The battery 296 generates electricity to supply power, and may be a rechargeable battery.

The indicator 297 may indicate states of the hardware 200 and/or a part thereof, e.g. the AP 211 related to, for example, booting, messages, and charging. The motor 298 may convert an electrical signal into mechanical vibration. The MCU 299 may control the sensor unit 240.

Although not shown, the hardware 200 may include a processor, e.g. a GPU, for supporting mobile TV. Such a processor may process media data conforming to a specification such as Digital Multimedia Broadcasting (DMB), Digital Video Broadcasting (DVB) and/or Media Forward Link Only (MediaFLO). Each component of the hardware described above may be composed of one or more elements, and component names may be varied according to a type of an electronic device. The hardware described in the present disclosure may further include a unit comparable to the above-described units, and one unit of the hardware may be removed or replaced with another unit. Some of the components of the hardware may be combined into one entity while maintaining a same functionality.

In the description, the word “module” may refer to a software component, a hardware component, a firmware component and/or a combination thereof. “Module” may be used interchangeably with “unit”, “logic”, “logical block”, “component”, “circuit” and/or the like. A module may be a smallest element and/or a part thereof acting as a single entity. A module may be a smallest element and/or a part thereof supporting one or more functions. A module may be implemented mechanically and/or electronically. For example, a module having a specific function may be implemented using at least one of an Application-Specific IC (ASIC), a Field-Programmable Gate Array (FPGA) and a Programmable-Logic Device (PLD).

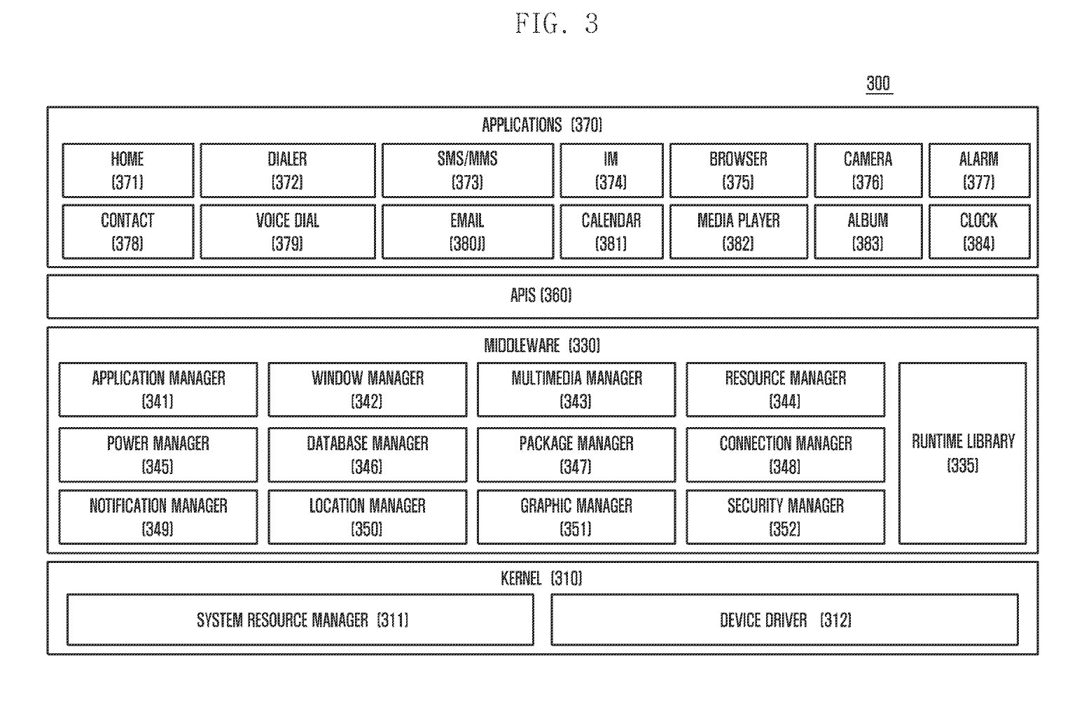

FIG. 3 illustrates a software configuration of an electronic device according to an embodiment of the present disclosure.

A software structure 300 may reside in the memory unit 130 of the electronic device 100 shown in FIG. 1. The software structure 300 may be composed of software, hardware, firmware, and/or a combination thereof. The software structure 300 may include an operating system controlling resources of the electronic device 100, and various applications, e.g. applications 370, running on the operating system. For example, the operating system may be Android, iOS, Windows, Symbian, Tizen, or Bada. Referring to FIG. 3, the software structure 300 may include a kernel 310, a middleware 330, APIs 360, and applications 370.

The kernel 310, which may correspond to the kernel 131 in FIG. 1, may include a system resource manager 311 and device drivers 312. The system resource manager 311 may include a process manager, a memory manager, and a file system manager (not shown). The system resource manager 311 may control, allocate and release system resources. The device drivers 312 may include a display driver, a camera driver, a Bluetooth driver, a shared memory driver, a USB driver, a keypad driver, a Wi-Fi driver, and an audio driver (not shown). The device drivers 312 may further include an inter-process communication (IPC) driver (not shown).

The middleware 330 may include a plurality of modules developed to provide common functions used by the applications 370. The middleware 330 may provide functions through the APIs 360 so that the applications 370 may efficiently utilize limited system resources internal to the electronic device 100. For example, as shown in FIG. 3, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphics manager 351, and a security manager 352.

The runtime library 335 may include library modules that are usable by compilers to add new functions via programming languages during application execution. The runtime library 335 may provide functions related to, for example, input/output, memory management, and arithmetic computation.

The application manager 341 may manage lifecycles of the applications 370. The window manager 342 may manage Graphical User Interface (GUI) resources for screen display. The multimedia manager 343 may identify a format of a media file for playback and perform encoding and decoding of the media file using a codec matching the identified format. The resource manager 344 may manage resources, such as source codes, memory space and storage space, used to execute the applications 370.

The power manager 345 may operate in cooperation with a basic input/output system (BIOS) to manage a power source, such as the battery 296 and provide information on operating power. The database manager 346 may permit one of the applications 370 to create, search and update a database. The package manager 347 may manage installation and update of applications distributed in a package file format.

The connectivity manager 348 may manage wireless links based on, for example, Wi-Fi and/or Bluetooth. The notification manager 349 may notify the user of events such as message reception, appointment arrival and proximity in a non-disruptive manner. The location manager 350 may manage location information of the electronic device. The graphics manager 351 may manage graphical effects for the user and manage related user interfaces. The security manager 352 may provide various security functions used for system security and/or user authentication. When the electronic device 100 supports telephony functionality, the middleware 330 may further include a telephony manager (not shown) to manage voice and/or video call functions.

In the middleware 132, existing modules may be combined in various ways to form new modules providing new functions. To provide differentiated functions, modules of the middleware 132 may be reconfigured according to types of operating systems. In a dynamic manner, an existing component of the middleware 132 may be removed and/or a new component may be added to the middleware 132. Hence, according to various embodiments, an existing component may be omitted, a new component may be added, or an existing component may be replaced by a similar component with a different name.

The APIs 360, which may correspond to the API 133 in FIG. 1, are sets of API functions and may be configured differently according to the operating systems. For example, Android and iOS may provide one API set for each platform, and Tizen may provide two or more API sets.

The applications 370, which may correspond to at least one of the application 134 in FIG. 1, may include a preloaded application, a third party application, and the like.

At least a part of the software structure 300 may be implemented as a computer program, which may be stored in various computer readable storage media. Instructions of the computer program may be executed by one or more processors. For example, the memory unit 220 may be a computer readable storage medium. At least a part of the software structure 300 may be executed by the processor unit 210. At least a part of the software structure 300 may include at least one of a module, a program, a routine, an instruction set and a process supporting one or more functions.

Component names of the software structure 300 may be varied according to types of operating systems. An existing component of the software structure 300 may be removed and/or a new component may be added to the software structure 300. Operations supported by components of the software structure 300 may be carried out in sequence, in parallel, by repetition, and/or heuristically. In a dynamic manner, one operation may be skipped and/or a new operation may be added.

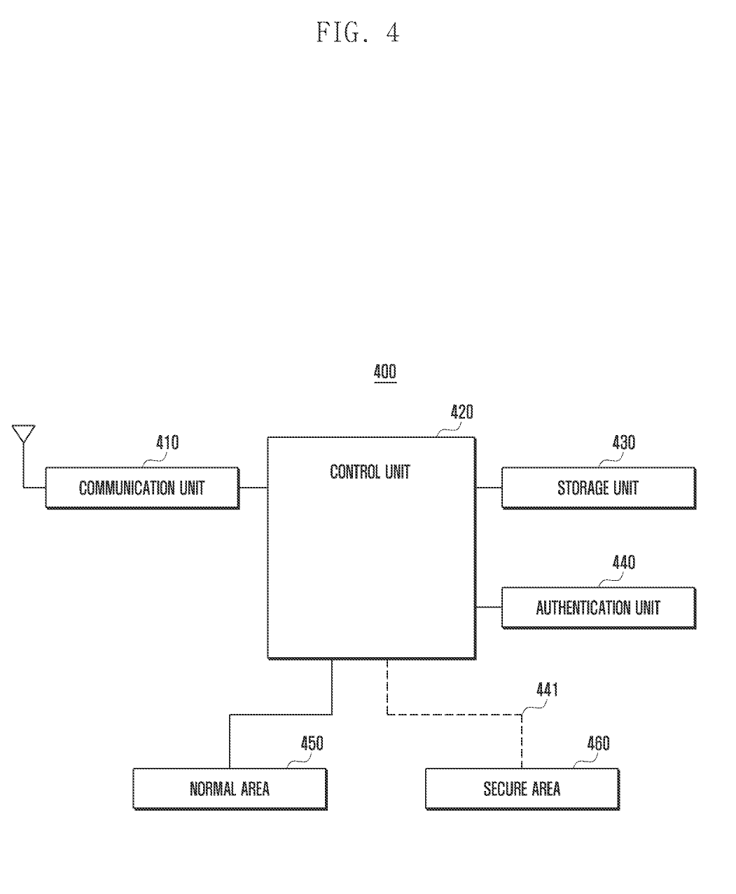

FIG. 4 is a block diagram of an electronic device according to an embodiment of the present disclosure.

Referring to FIG. 4, an electronic device 400 may include a communication unit 410, a control unit 420, a storage unit 430, an authentication unit 440, a normal area 450, and a secure area 460.

The communication unit 410 may connect the electronic device 400 to an external electronic device, e.g. the server 164, for communication. The communication unit 410 may correspond to the communication unit 160 of FIG. 1 and/or the communication unit 230 of FIG. 2.

The control unit 420 may receive instructions from other components, e.g. the communication unit 410, the storage unit 430, the authentication unit 440, the normal area 450, the secure area 460, may decode the instructions, and may perform operations and/or data processing according to the decoded instructions. The control unit 420 may include various processors, e.g. an AP, a CP, a Central Processing Unit (CPU), and a GPU), and may correspond to the processor unit 120 of FIG. 1 or the processor unit 210 of FIG. 2.

The storage unit 430 may store instructions and data received from and/or generated by the control unit 420 and/or other components. The storage unit 430 may include an internal memory and an external memory, and may correspond to the memory unit 130 of FIG. 1 and/or the memory unit 220 of FIG. 2.

The authentication unit 440 may verify access from other components, e.g. the communication unit 410, the control unit 420, the storage unit 430, the normal area 450, to the secure area 460. For example, when authentication information is received through the communication unit 410 from an external device, such as the server 164, the authentication unit 440 may generate a linker 441 and send the linker 441 to the control unit 420. The authentication unit 440 may generate authentication information, and may generate the linker 441 if the generated authentication information matches the received authentication information. Here, the linker 441 may refer to a key for accessing a particular data item and/or module in the secure area 460 and may contain, for example, address information. The level and/or right for performing and/or executing linker generation may correspond to a hardware level, e.g. a TrustZone Integrity Measurement Architecture (TIMA) level. The linker 441, which links the control unit 420 with the secure area 460, may be indicated by an interface and/or a path. The control unit 420 may use the linker 441 to locate, read, and/or update, e.g. delete and/or modify, desired data stored in the secure area 460. The control unit 420 may use the linker 441 to locate, read, and/or update a desired software structure. When access to the secure area 460 is ended, the authentication unit 440 may change the address of specific data in the secure area 460 and/or software structure, e.g. a Logical Block Address (LBA). Later, when the linker 441 is created, the authentication unit 440 may add the changed address information to the linker 441.

The authentication unit 440 may be composed of software, hardware, e.g. processors, firmware, and/or a combination thereof. For example, a portion of a processor may operate as the control unit 420 and other portion of the processor may operate as the authentication unit 440.

The normal area 450 may store instructions and data, and may include software structures. The secure area 460 may store instructions and data, and may include software structures. Each of the normal area 450 and the secure area 460 may be a region of the storage unit 430. Each of the normal area 450 and the secure area 460 may include at least one of an internal memory and an external memory, separately from the storage unit 430. Meanwhile, the secure area 460 may be composed of virtual images. That is, data and/or applications may be stored individually as virtual images in the secure area 460. Virtual images may be encrypted, e.g. using an Advanced Encryption Standard (AES) cipher algorithm with 256-bit keys, and stored in the secure area 460. Hence, the linker 441 may include information used for decrypting a virtual image, e.g. a decryption key.

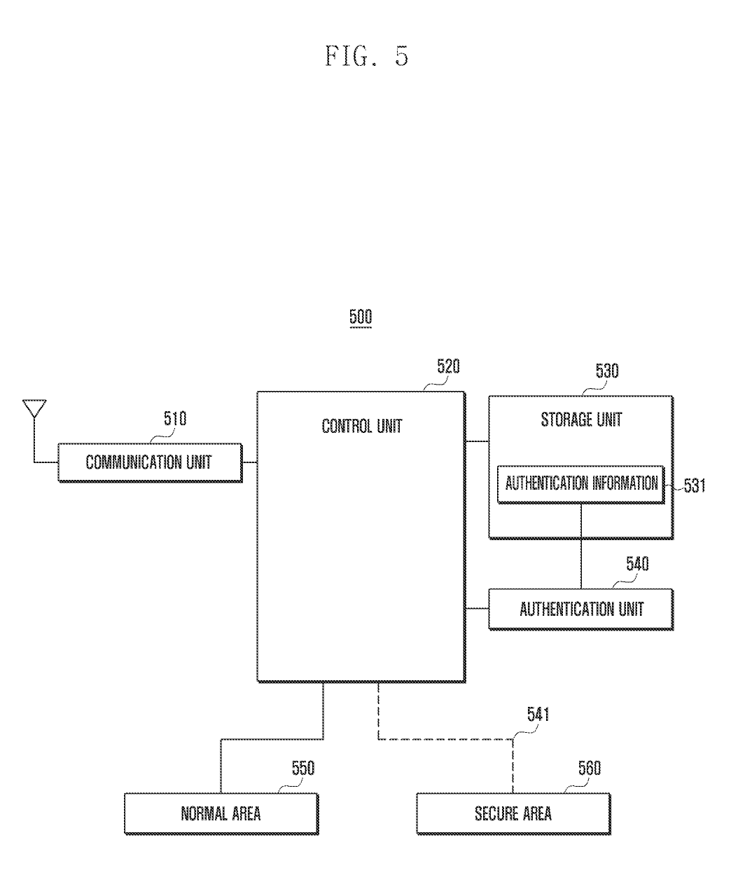

FIG. 5 is a block diagram of an electronic device according to an embodiment of the present disclosure.

Referring to FIG. 5, the electronic device 500 may include a communication unit 510, a control unit 520, a storage unit 530, an authentication unit 540, a normal area 550, and a secure area 560.

The communication unit 510 may connect the electronic device 500 to an external electronic device, e.g. the server 164, for communication. The communication unit 510 may correspond to the communication unit 160 of FIG. 1, the communication unit 230 of FIG. 2, and/or the communication unit 410 of FIG. 4.

The control unit 520 may receive instructions from other components, e.g. the communication unit 510, the storage unit 530, the authentication unit 540, the normal area 550, the secure area 560, may decode the instructions, and may perform operations and/or data processing according to the decoded instructions.

The storage unit 530 may store instructions and data received from and/or generated by the control unit 520 or other components. The storage unit 530 may store authentication information 531 received from the control unit 520 and/or the authentication unit 540. The storage unit 530 may correspond to the memory unit 130 of FIG. 1 and/or the memory unit 220 of FIG. 2. Here, the authentication information 531 may be stored in the secure area 560. The authentication information 531 may be generated by a component, e.g. the authentication unit 540, of the electronic device 500 and/or an external device, e.g. the server 164. The authentication information 531 may be periodically updated by the server 164. Meanwhile, an additional password for access to the secure area 560 may be stored in the storage unit 530 and/or secure area 560. Such a password may be created by the server 164 and sent together with authentication information 531 to the electronic device 500. Alternatively, the control unit 520 and/or authentication unit 540 may request the user to enter a password, e.g. may display a password input window on a display unit, and may store the input password in the storage unit 530 and/or the secure area 560. Such a password may be associated with authentication information 531. That is, a password and associated authentication information 531 may have a common lifecycle. For example, when authentication information 531 is discarded and/or removed owing to valid period expiration, the associated password may also be discarded.

The authentication unit 540 may verify access from other components, e.g. the communication unit 510, the control unit 520, the storage unit 530, and the normal area 550, to the secure area 560. For example, the authentication unit 540 may examine whether the authentication information 531 is valid, and may create a linker 541 and send the linker 541 to the control unit 520 if the authentication information 531 is valid, e.g. if the effective period assigned to the authentication information 531 is not expired. The authentication unit 540 may be an authentication module contained in the processor unit 120 of FIG. 1 and/or the processor unit 210 of FIG. 2. The normal area 550 may store instructions and/or data, and may include programming modules. The secure area 560 may store instructions and/or data, and may include programming modules.

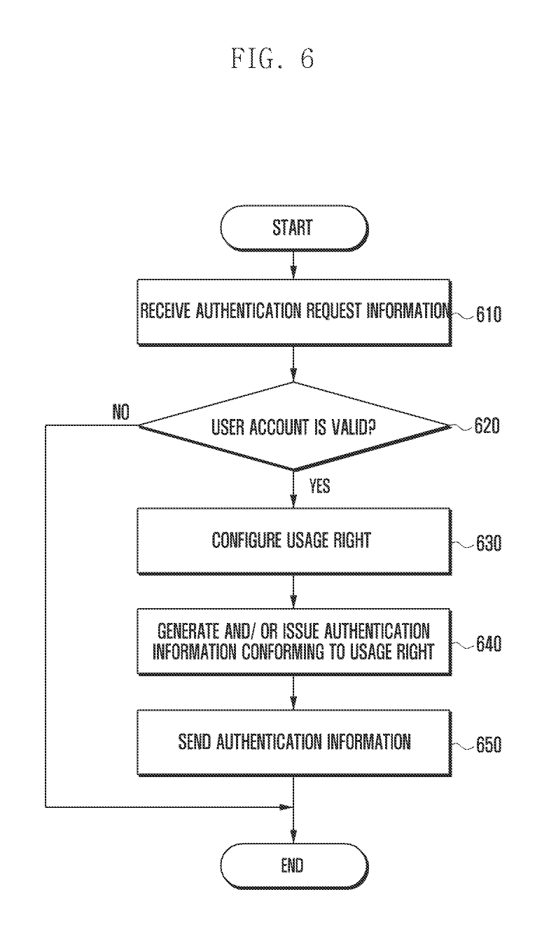

FIG. 6 is a flowchart of a user authentication procedure performed by an authentication server according to an embodiment of the present disclosure.

Referring to FIG. 6, at operation 610, the server 164 receives authentication request information from an electronic device, such as the electronic device 400. The authentication request information may include information on a user account, e.g. an identifier (ID) and a password. The authentication request information may further include at least one of location information, period information, and device information. Here, the location information indicates a location of the electronic device 400, such as GPS information and/or address information. The period information is reference information used to assign a valid period to authentication information, e.g. business hours, an expected time of entrance to a given place, and/or any other similar and/or suitable time and/or time period. The device information is information for identifying the electronic device 400, such as device type, e.g. a smartphone, a tablet computer, an OS version, camera information, a Media Access Control (MAC) address, Radio-Frequency IDentification (RFID) information, Wi-Fi information, and NFC information.

Upon reception of an authentication request, at operation 620, the server 164 determines whether the user account is valid. For example, the server 164 may determine that the user account is valid if received account information matches pre-stored account information.

If the user account is valid, the procedure proceeds to operation 630 at which the server 164 configures a usage right for authentication information to be generated. Specifically, the server 164 may assign a valid period to the authentication information on the basis of the received period information. For example, when the authentication request is received at 10 A.M., the valid period may be set to 8 hours, i.e., from 10 A.M. to 6 P.M. In addition to or in place of the valid period, the server 164 may designate a usage place for the authentication information on the basis of the received location information. The server 164 may designate a usage count for the authentication information. The server 164 may attach a condition for extending the valid period and designate an extension count.

At operation 640, the server 164 generates and/or issues authentication information in accordance with the usage right. Such authentication information may be used as a first key for accessing the secure area 460. The authentication information may include a one-time password (OTP) and usage right information. Here, as the OTP is issued through user authentication, e.g. operation 620, it may be referred to as secure-OTP (S-OTP). The usage right information may be composed of setting values indicating at least one of the valid period, the usage place, the usage count, and the condition for valid period extension and the extension count.

At operation 650, the server 164 sends the authentication information to the electronic device 400.

When the valid period is configured for the authentication information, the authentication unit 440 of the electronic device 400 may permit another component, e.g. the control unit 420, to access the secure area 460 for the valid period. Access to the secure area 560 may be denied after expiration of the valid period. When the authentication information contains an indication for valid period extension, the authentication unit 540 may reconfigure the valid period according to a user request and permit access to the secure area 560 for the reconfigured valid period.

When the authentication information contains usage place information, the authentication unit 440 may identify the current location of the electronic device 400 using a communication module, e.g. a GPS module, and a Wi-Fi module, and may determine whether the current location matches the usage place information. If the current location matches the usage place information, the authentication unit 440 may permit the control unit 420 to access the secure area 460. Otherwise, the authentication unit 440 may deny access to the secure area 460.

When the authentication information contains usage count information, the authentication unit 440 may count the number of access requests made by the control unit 420 and determine whether the counted number exceeds the usage count. The authentication unit 440 may grant access to the secure area 460 if the counted number does not exceed the usage count, and deny access to the secure area 460 otherwise.

The user authentication procedure described in FIG. 6 may be performed by the electronic device 400. For example, the authentication unit 440 may determine whether a password received from the user input unit matches a stored password, and may generate authentication information with a usage right if the received password matches the stored password.

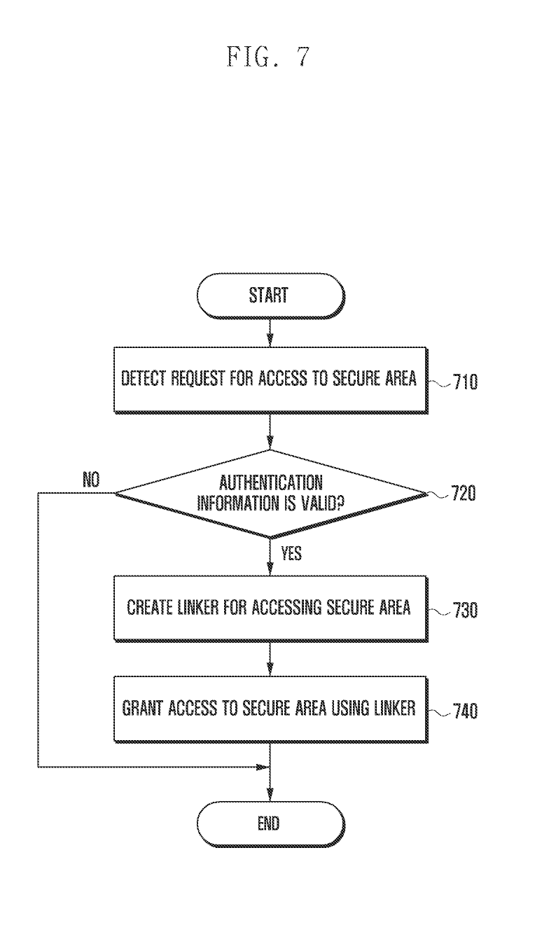

FIG. 7 is a flowchart of a method for controlling access to a secure area of an electronic device according to an embodiment of the present disclosure.

Referring to FIG. 7, at operation 710, the authentication unit 440 of the electronic device 400 detects a request for access, which may be referred to as an access request, to the secure area 460 from another component, e.g. the control unit 420. Upon reception of the access request, at operation 720, the authentication unit 440 determines whether the authentication information, which may be generated by the electronic device 400 and/or an external device such as the server 164, is valid. For example, the authentication unit 440 may examine the valid period and/or the usage place attached to the authentication information. If the authentication information is valid, at operation 730, the authentication unit 440 creates a linker, e.g. the linker 441, as a second key, for accessing the secure area 460. At operation 740, the authentication unit 440 permits the control unit 420 to access the secure area 460, or in other words, the authentication unit 440 may grant access, to the control unit 420, to access the secure area 460 using the linker 441. That is, the control unit 420 may use the linker 441 to access desired data, application, hardware and/or firmware of the secure area 460.

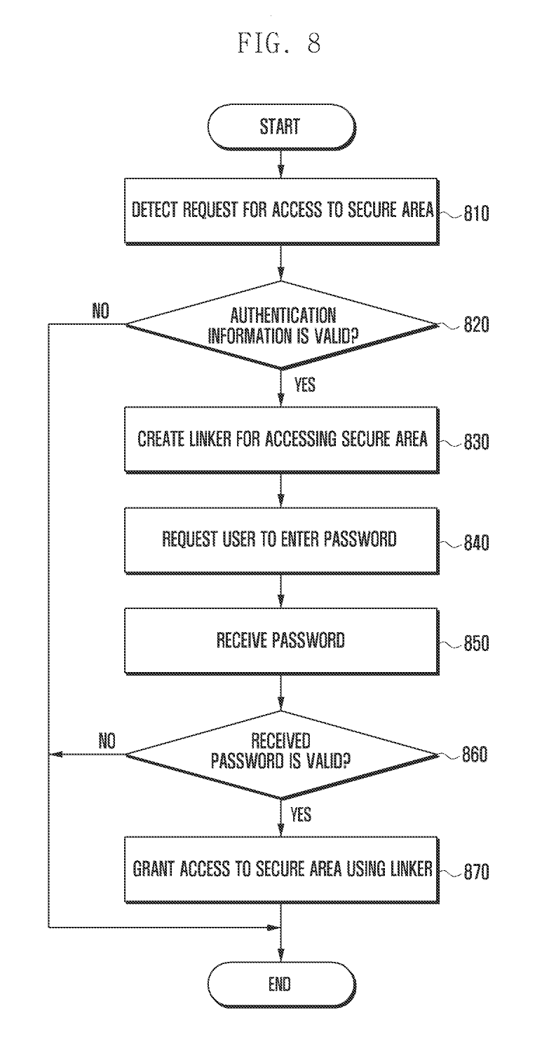

FIG. 8 is a flowchart of a method for controlling access to a secure area of an electronic device according to an embodiment of the present disclosure.

Referring to FIG. 8, at operation 810, the authentication unit 540 of the electronic device 500 detects a request for access to the secure area 560 from another component, e.g. the control unit 520. Upon reception of the access request, at operation 820, the authentication unit 540 determines whether the authentication information 531 stored in the memory unit, e.g. the secure area 560 and/or the storage unit 530, is valid. If the authentication information 531 is valid, at operation 830, the authentication unit 540 creates the linker 541 for access to the secure area 560. At operation 840, the authentication unit 540 requests the user to enter a password as a third key for accessing the secure area 560. For example, the authentication unit 540 controls the display unit to display a password input window. At operation 850, the authentication unit 540 receives the password from the user, e.g., the authentication unit 540 receives the password from the user via a user input unit. At operation 860, the authentication unit 540 determines whether the received password is valid. For example, the authentication unit 540 may examine whether the received password matches the stored password in association with the authentication information 531. If the two passwords match, then, at operation 870, the authentication unit 540 permits the control unit 520 to access the secure area 560, or in other words, the authentication unit 540 may grant access, to the control unit 520, to access the secure area 560 using the linker 541. That is, the control unit 520 may use the linker 541 to access desired data, application, hardware and/or firmware of the secure area 560.

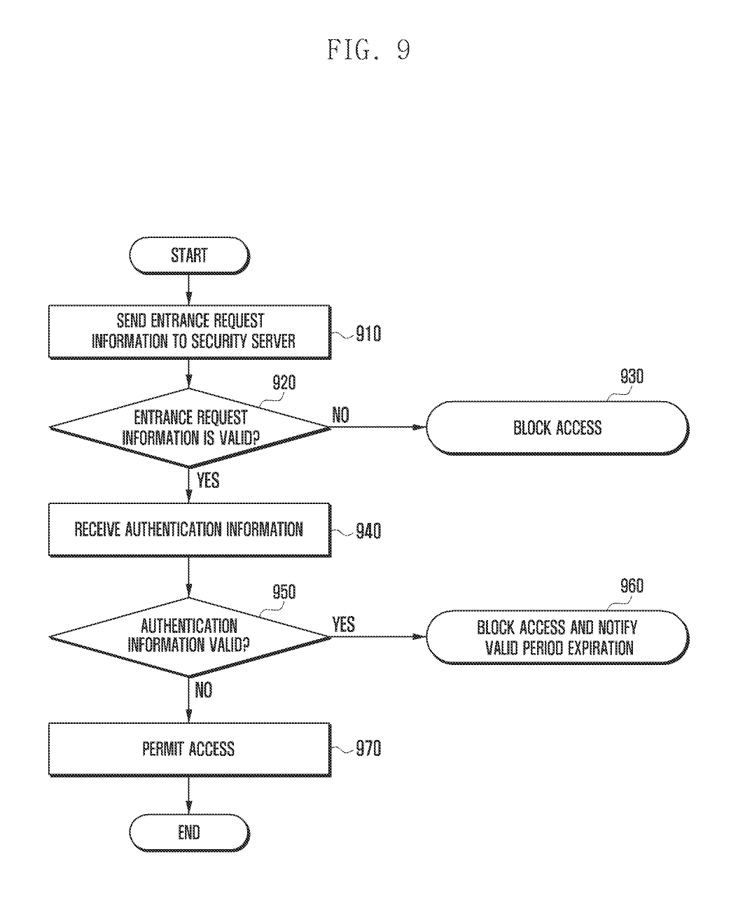

FIG. 9 is a flowchart of a method for controlling access to a secure area of the electronic device according to an embodiment of the present disclosure.

Referring to FIG. 9, at operation 910, the control unit 420 of the electronic device 400 controls a communication module, e.g. an RFID tag, to send authentication request information, e.g. entrance request information, to a security server, e.g. the server 164. For example, the RFID tag may send entrance request information to an RFID reader installed in a gate, and the RFID reader may forward the entrance request information to the server 164. Here, the entrance request information may include user account information, e.g. a name, an ID, and device information. At operation 920, the server 164 determines whether the entrance request information is valid. If the entrance request information is not valid, the server 164 may send an invalid indication to the electronic device 400. The communication unit 410 of the electronic device 400 may receive the invalid indication and forward the invalid indication to the authentication unit 440. At operation 930, the authentication unit 440 blocks access to the secure area 460.

If the entrance request information is valid, the server 164 may configure a usage right, e.g. the valid period, may issue authentication information conforming to the usage right, and may send the authentication information to the electronic device 400. At operation 940, the authentication unit 440 receives the authentication information through the communication unit 410. At operation 950, the authentication unit 440 determines whether the authentication information is valid. For example, the authentication unit 440 may determine expiration of the valid period associated with the authentication information. Upon expiration of the valid period, at operation 960, the authentication unit 440 blocks access to the secure area 460. In addition, the authentication unit 440 may notify the user of expiration of the valid period, e.g. may display a notification through a display unit. Upon non-expiration of the valid period, or in other words, if the valid period is not expired, at operation 970, the authentication unit 440 permits access to the secure area 460. Hence, the user may enter a desired location, e.g. an office, through the gate and may access the secure area 460 at the office for the valid period, e.g. during working and/or business hours.

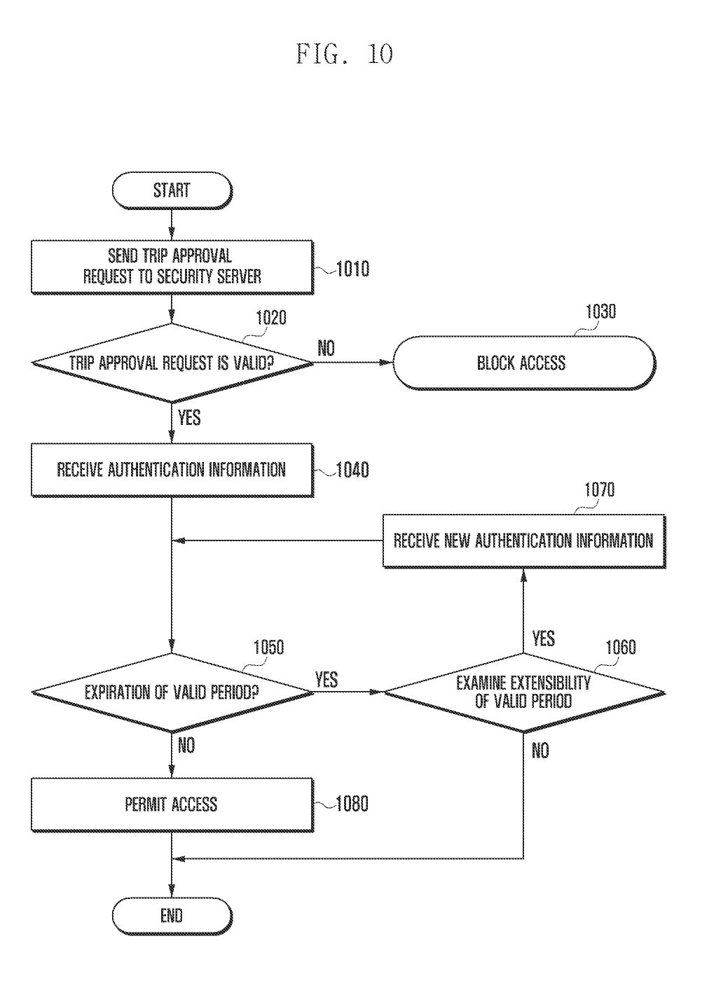

FIG. 10 is a flowchart of a method for controlling access to a secure area of the electronic device according to an embodiment of the present disclosure.

Referring to FIG. 10, at operation 1010, the control unit 420 of the electronic device 400 controls a communication module, e.g. a Wi-Fi module, to send authentication request information, e.g. a trip approval request, to the security server, e.g. the server 164. Here, the trip approval request may contain information on a user account, a trip period, and a trip place. At operation 1020, the server 164 determines whether the trip approval request is valid. If the trip approval request is not valid, the server 164 may send an invalid indication to the electronic device 400. The communication unit 410 of the electronic device 400 may receive the invalid indication and forward the invalid indication to the authentication unit 440. At operation 1030, the authentication unit 440 blocks access to the secure area 460.

If the trip approval request is valid, the server 164 may configure a usage right, e.g. the valid period, an extensibility of the valid period, etc., may issue authentication information conforming to the usage right, and may send the authentication information to the electronic device 400. At operation 1040, the authentication unit 440 receives the authentication information through the communication unit 410. At operation 1050, the authentication unit 440 determines whether the authentication information is valid, or in other words, determines expiration of the valid period. If the authentication information is not valid, e.g. expiration of the valid period has occurred, then at operation 1060, the authentication unit 440 examines the extensibility of the valid period. For example, when the authentication information contains an indication for valid period extension, the authentication unit 440 may send a reissue request for authentication information through the communication unit 410 to the server 164. In response to the reissue request, the server 164 may issue second authentication information and send the same to the electronic device 400. Here, the second authentication information may contain or not contain an indication for valid period extension. At operation 1070, the authentication unit 440 receives the second authentication information, or in other words, new authentication information, through the communication unit 410. Thereafter, the procedure returns to operation 1050.

If the authentication information is valid at operation 1050, at operation 1080, the authentication unit 440 permits access to the secure area 460. Hence, the user may access the secure area 460 at a location out of or away from a given site, e.g. an office, for the valid period, e.g. the trip period. Meanwhile, the electronic device 400 may store information for an authentication request, e.g. the ID and the password. The electronic device 400 may send the ID and the password to the server 164 to request for issuance of authentication information. Here, a valid period may be attached to the ID and password. When an ID or a password whose valid period has expired is received, the server 164 may cancel issuance of authentication information.

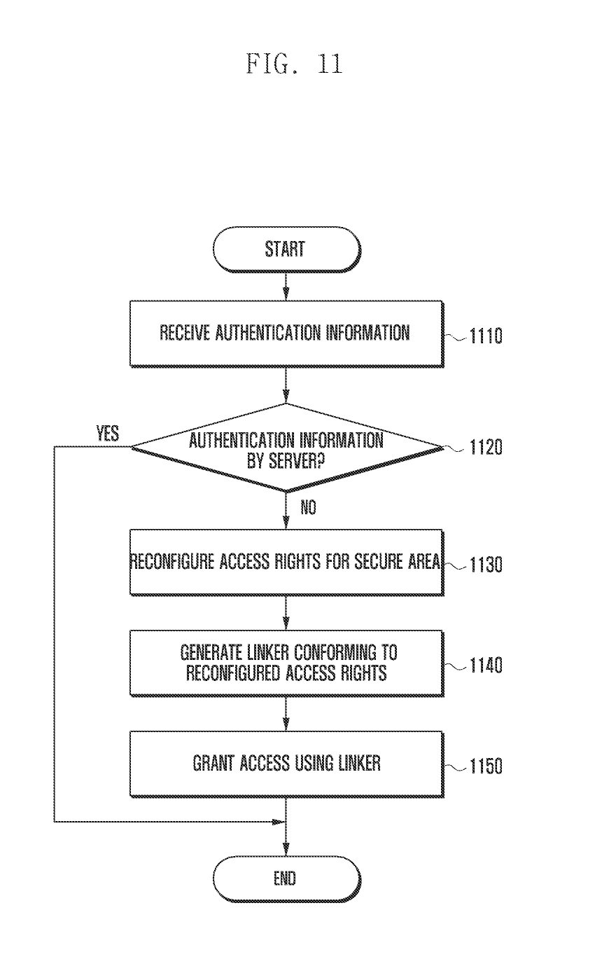

FIG. 11 is a flowchart of a method for controlling access to a secure area of the electronic device according to an embodiment of the present disclosure. When communication with the security server is not possible, the authentication unit 540 of the electronic device 500 may grant limited access to the secure area 560 by use of authentication information received from an authentication server in advance.

Referring to FIG. 11, at operation 1110, the authentication unit 540 receives authentication information from an authentication server and stores the authentication information in the memory, e.g. the storage unit 530 and/or the secure area 560.

At operation 1120, the authentication unit 540 determines the possibility of authentication by the server 164, or in other words, determines whether authentication by the server 164 may be performed. If authentication by the server 164 is not possible owing to lack of response, at operation 1130, the authentication unit 540 reconfigures the access right for the secure area 560. For example, the access right may be restricted so that data stored in the secure area 560 can be read, but cannot be modified. The authentication unit 540 may reconfigure the usage rights for the authentication information 531 at operation 1130. For example, the valid period may be reduced by one day.

At operation 1140, the authentication unit 540 generates a linker conforming to the reconfigured access rights. At operation 1150, the authentication unit 540 permits the control unit 520 to access the secure area 560, or in other words, the authentication unit 540 grants access, to the secure area, using the linker. That is, the control unit 520 may use the linker to access desired data, application, hardware and/or firmware of the secure area 560. Here, the data can be read only. Only some of functions of the application, hardware and/or firmware may be executable.

When the server 164 responds, e.g. the authentication information is received, the authentication unit 540 may generate a linker and forward the linker to the control unit 520. Hence, the control unit 520 may use the linker to access desired data, application, hardware and/or firmware of the secure area 560. Here, the data can be read and modified. The control unit 520 may write new data in the secure area 560. The control unit 520 may execute all the functions of the application, hardware and/or firmware.

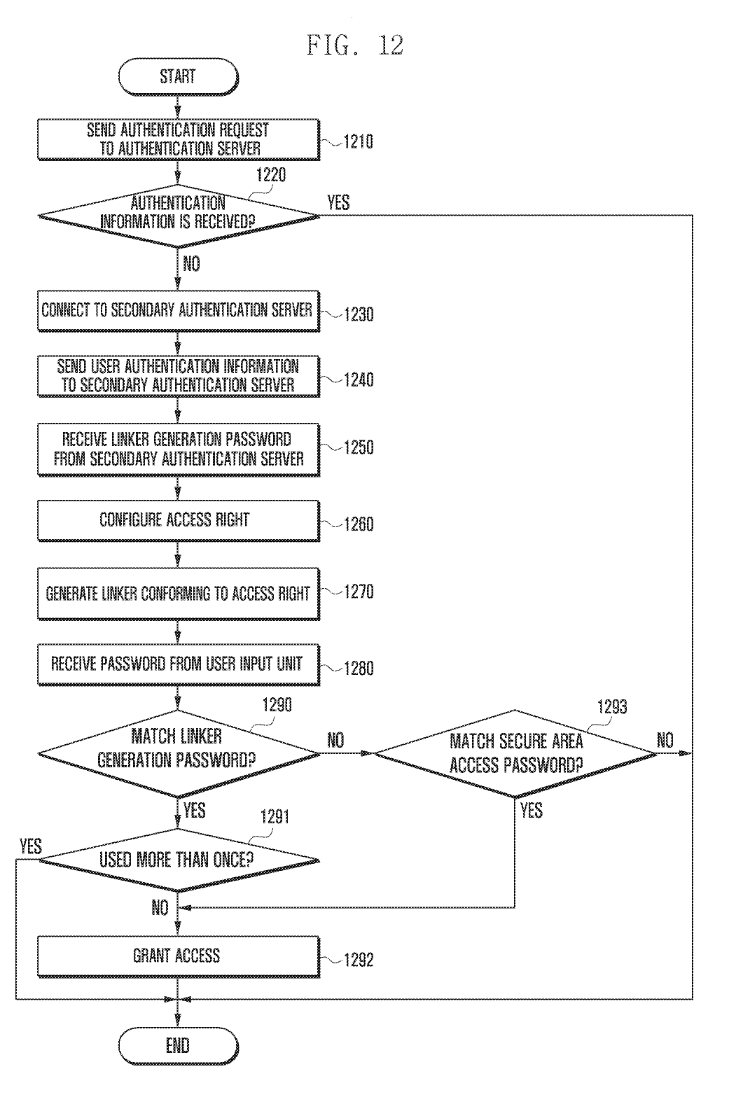

FIG. 12 is a flowchart of a method for controlling access to a secure area of the electronic device according to an embodiment of the present disclosure.

When communication with the authentication server is not possible, the authentication unit 440 of the electronic device 400 may communicate with a second authentication server to generate a linker and grant limited access to the secure area 460.

Referring to FIG. 12, at operation 1210, the authentication unit 440 controls the communication unit 410 to send authentication request information to the authentication server. At operation 1220, the authentication unit 440 determines whether authentication information is received from the authentication server.

When authentication information is not received, at operation 1230, the authentication unit 440 controls the communication unit 410 to connect to a secondary authentication server. At operation 1240, the authentication unit 440 controls the communication unit 410 to send user authentication information, e.g. an ID and a password, to the secondary authentication server. When the received user authentication information matches pre-stored user authentication information, the secondary authentication server may issue a linker generation password as a fourth key for accessing the secure area 460. Here, a usage limit of ‘1’ may be attached to the linker generation password.

At operation 1250, the authentication unit 440 controls the communication unit 410 to receive the linker generation password and the usage limit from the secondary authentication server. Upon reception of the linker generation password, the authentication unit 440 may set a usage count SUM to ‘0’. At operation 1260, the authentication unit 440 configures the access right for the secure area 460. For example, the access right may be limited so that data stored in the secure area 460 can be read, but cannot be modified. At operation 1270, the authentication unit 440 generates a linker conforming to the access right. At operation 1280, the authentication unit 440 controls the display unit to display a password input window and to receive a password from the user input unit.

At operation 1290, the authentication unit 440 determines whether the password input by the user matches the linker generation password. If the two passwords match, the authentication unit 440 adds ‘1’ to the usage count SUM for the linker generation password. At operation 1291, the authentication unit 440 determines whether the usage count SUM is greater than or equal to the usage limit, or in other words, if the linker generation password is being used more than once. If the usage count SUM is less than the usage limit, e.g. 1, i.e., the linker generation password is used for the first time, at operation 1292, the authentication unit 440 grants access, such as limited access, to the secure area 460, e.g. data read permitted, but data write prohibited. If the usage count SUM is equal to the usage limit, e.g. ‘1’, i.e., the linker generation password is used for the second time, the authentication unit 440 may completely block access to the secure area 460.

If the input password does not match the linker generation password at operation 1290, at operation 1293, the authentication unit 440 determines whether the input password matches the secure area access password, which may be another key for accessing the secure area 460. If the two passwords match, at operation 1292, the authentication unit 440 grants limited access to the secure area 460. Otherwise, the authentication unit 440 may completely block access to the secure area 460.

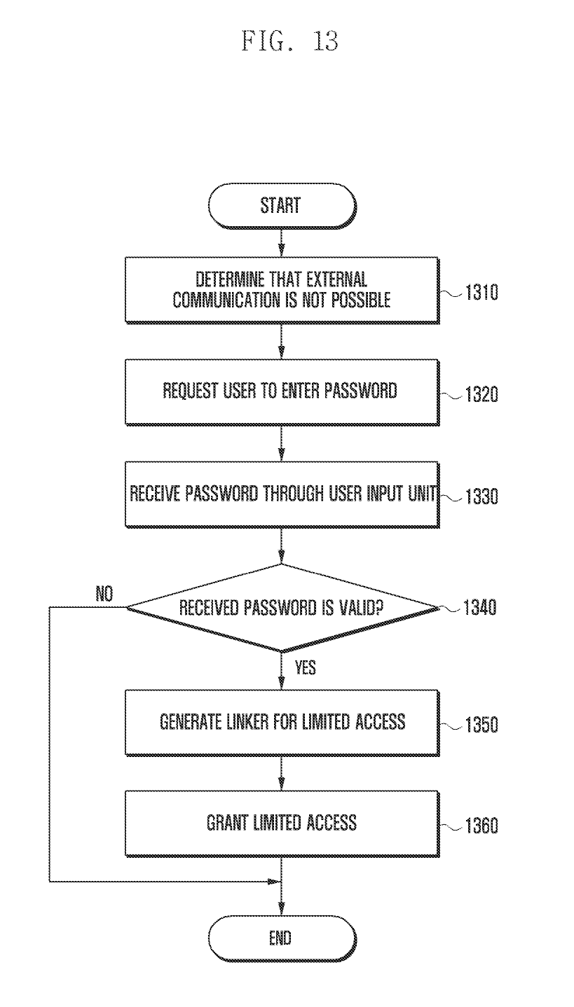

FIG. 13 is a flowchart of a method for controlling access to a secure area of an electronic device according to an embodiment of the present disclosure.

When communication with the outside is not possible, i.e., when external communication is not possible, the authentication unit 440 of the electronic device 400 may grant limited access to the secure area 460.

Referring to FIG. 13, at operation 1310, an authentication unit 440 is aware that communication with the authentication server and/or the Internet is not possible, or in other words determines that external communication is not possible. For example, when settings are configured so as not to allow any wireless connection and/or wireless communication, e.g. using Wi-Fi, Bluetooth and/or cellular communication, the control unit 420 may deactivate the communication unit 410. Although the communication unit 410 is activated, communication with the authentication server and/or the Internet may not be possible because of network problems and/or other environmental causes. For example, the control unit 420 receives information, related to signal strength from the communication unit 410. When the signal strength is lower than a reference value, the control unit 420 may determine that communication is not possible and may notify this determination to the authentication unit 440. If communication is not possible, at operation 1320, the authentication unit 440 requests the user to enter a password. For example, the authentication unit 440 may control the display unit to display a password input window on a user input unit. At operation 1330, the authentication unit 440 receives the password through the user input unit. At operation 1340, the authentication unit 440 determines whether the received password is valid, e.g., determines whether the received password matches a pre-stored offline password, which may be another key for accessing the secure area 460. If the two passwords match, at operation 1350, the authentication unit 440 generates a linker for limited access. At operation 1360, the authentication unit 440 grants limited access to the secure area 460 through the linker. Otherwise, the authentication unit 440 may completely block access to the secure area 460.

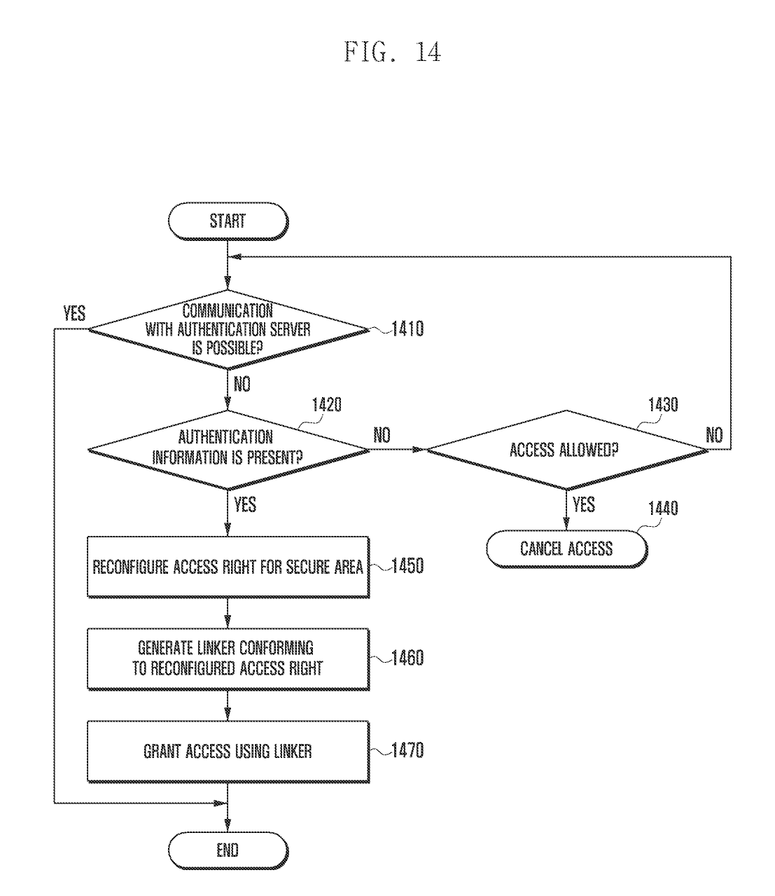

FIG. 14 is a flowchart of a method for controlling access to a secure area of the electronic device according to another embodiment of the present disclosure. The electronic device 500 may block an unauthorized attempt to access the secure area 560.

Referring to FIG. 14, at operation 1410, the authentication unit 540 determines whether communication with the authentication server is possible. If communication with the authentication server is not possible, at operation 1420, the authentication unit 540 determines whether authentication information is present. If authentication information is not present, at operation 1430, the authentication unit 540 determines whether another component, e.g. the control unit 520, is allowed to access the secure area 560. If another component is allowed to access the secure area 560, the authentication unit 540 may determine that linkage between the control unit 520 and the secure area 560 is wrong. Hence, at operation 1440, the authentication unit 540 releases the link between the control unit 520 and the secure area 560, e.g. releases a connection through the linker 441, cancelling access to the secure area 560. If another component is not allowed to access the secure area 560, the procedure returns to operation 1410.

If authentication information is present at operation 1420, e.g. the authentication information 531 is present, at operation 1450, the authentication unit 540 reconfigures the access right for the secure area 560. For example, the access right may be limited so that data stored in the secure area 560 can be read, but cannot be modified. The authentication unit 540 may reconfigure the usage right for the authentication information 531 at operation 1450. For example, the valid period may be reduced by one day.

At operation 1460, the authentication unit 540 generates a linker conforming to the reconfigured access right. At operation 1470, the authentication unit 540 permits the control unit 520 to access the secure area 560, or in other words, the authentication unit 540 grants access, to the secure area 560, using the linker. That is, the control unit 520 may use the linker to access desired data, application, hardware and/or firmware of the secure area 560. Here, the data can be read only. Only some of functions of the application, hardware and/or firmware may be executable.

If communication with the authentication server is possible at operation 1410, the electronic device 500 may receive authentication information from the authentication server and generate a linker. Hence, the control unit 520 may use the linker to access desired data, application, hardware and/or firmware of the secure area 560. Here, the data can be read and modified. The control unit 520 may write new data in the secure area 560. The control unit 520 may execute all the functions of the application, hardware and/or firmware.

The method of the present disclosure may be implemented as computer programs and may be stored in various computer readable storage media. The computer readable storage media may store program instructions, data files, data structures, and combinations thereof. The program instructions may include instructions developed specifically for the present disclosure and existing general-purpose instructions. The computer readable storage media may include magnetic media such as a hard disk and floppy disk, optical media such as a Compact Disc-Read Only Memory (CD-ROM) and DVD, magneto-optical media such as a floptical disk, and memory devices such as a ROM, RAM and flash memory. The program instructions may include machine codes produced by compilers and high-level language codes executable through interpreters.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating an electronic device, the method comprising:
determining validity of a first key;
generating, when the first key is valid, a second key; and
granting access to a designated area of the electronic device by use of the second key.

2. The method of claim 1, further comprising:
detecting an access request for the designated area;
sending, upon detection of the access request, a request message for the first key to an external device; and
receiving a response message containing the first key from the external device.

3. The method of claim 2, wherein the request message contains at least one of location information, period information, user information, and device information.

4. The method of claim 1, wherein the second key contains address information of the designated area, and
wherein the granting of the access to the designated area comprises sending the second key to a component of the electronic device that sent the access request.

5. The method of claim 1, further comprising changing an address of the designated area after access according to the granting of the access to the designated area is completed.

6. The method of claim 1, wherein the determining of the validity of the first key comprises determining expiration of a valid period attached to the first key.

7. The method of claim 6, further comprising extending the valid period.

8. The method of claim 1, further comprising:
receiving a third key; and
determining validity of the third key,
wherein the second key is generated when the third key is valid.

9. The method of claim 1, further comprising:
storing the first key;
determining validity of the stored first key in response to a request for a second access to the designated area; and
granting the second access when the stored first key is valid.

10. The method of claim 9, wherein the granting of the second access comprises limiting an access right attached to the second access.

11. The method of claim 10, wherein the limiting of the access right attached to the second access comprises permitting only at least one read operation on the designated area.

12. The method of claim 9, wherein the determining of the validity of the stored first key comprises determining that the stored first key is valid when the valid period attached to the stored first key has not expired.

13. The method of claim 12, further comprising deleting the stored first key when the valid period has expired.

14. The method of claim 1, wherein the first key contains a one-time password (OTP).

15. The method of claim 14, wherein the first key further contains at least one of valid period information and access right information.

16. The method of claim 1, further comprising:
sending a request message for the first key to an external device; and
granting limited access to the designated area when no response to the request message for the first key is received from the external device.

17. The method of claim 1, further comprising:
sending a request message for the first key to an external device; and
blocking access to the designated area when no response to the request message for the first key is received from the external device.

18. An electronic device comprising:
a communication unit configured to communicate with an external device;
a memory unit including a normal area and a designated area;
a control unit configured to control the communication unit and to access the memory unit; and
an authentication unit configured to perform a process of determining validity of a first key, the first key being at least one of received through the communication unit and stored in the memory unit, to generate a second key when the first key is valid, and to permit the control unit to access the designated area by use of the second key.

19. The electronic device of claim 18, wherein the control unit and the authentication unit are realized by at least one processor.

20. The electronic device of claim 18, wherein the at least one processor is configured to detect an access request for the designated area, to control the communication unit to send a request message for the first key to an external device upon detection of the access request, and to receive a response message containing the first key from the external device through the communication unit.
